(19) United States
(12) Patent Application Publication
(10) Pub. No.: US 2025/0063396 A1
(43) Pub. Date: Feb. 20, 2025

(54) COMPUTERIZED SYSTEM, METHOD AND APPARATUS FOR INTEGRATED DEVICE TESTING, VERIFICATION AND CONFIGURATION

(71) Applicant: PLUME DESIGN, INC., Palo Alto, CA (US)

(72) Inventors: Mladen BARJAKTAREVIC, Ljubljana (SI); Matej ZEVNIK, Kranj (SI); Nikola LATKOVIC, Podgorica (ME); Damjan PEGAM, Polzela (SI); Aljaz DOBNIKAR, Ljubljana (SI)

(21) Appl. No.: 18/451,199

(22) Filed: Aug. 17, 2023

(51) Int. Cl. H04W 24/06; H04L 43/50; H04W 16/22; H04W 24/02

(52) U.S. Cl. CPC H04W 24/06; H04L 43/50; H04W 16/22; H04W 24/02; H04W 84/12

(57) ABSTRACT

Disclosed are systems and methods that provide a novel functional, computerized testing framework for an integrated, unified standard testbed for network (e.g., WiFi) devices. In some aspects, the disclosed framework involves components referred to as OpenSync Reference Testbed (OSRT) and Unified Standard Testbed (USTB). OSRT provides a reference testbed for end-to-end (E2E) system testing for firmware release verification (FRV) and for functional unit testing (FUT). USTB corresponds to standard devices, software images, wiring schemes, and the process for setting up and running a functional testbed for networked devices. In some embodiments, OSRT can include a fully assembled USTB with a predetermined number (e.g., three (3)) of reference extenders, which can allow for the testing configuration and functionality discussed herein. The disclosed framework can provide novel functionality for testing, verifying and configuring network equipment and connections for a particular and/or set of software stacks.

### FIELD OF THE DISCLOSURE

The present disclosure is generally related to networking systems and methods, and more particularly, to a computerized framework for performing integrated device testing, verification and configuration based therefrom.

### BACKGROUND

Devices, particularly wireless fidelity (WiFi) devices, such as access point (AP) devices and client devices capable of being connected thereto, can be tested and configured prior to shipment.

### SUMMARY OF THE DISCLOSURE

Accordingly, device testing and calibration processes may vary depending on the manufacturer, the type of device, and its intended use. Such testing can involve, but is not limited to, functional testing, radio frequency (RF) testing, interoperability testing, security testing, firmware and software validation testing, regulatory compliance testing, Quality Assurance (QA) and Quality Control (QC), and the like, or some combination thereof.

In some embodiments, function testing can involve the device undergoing comprehensive functional testing to ensure that all its features and functionalities work as intended. For example, this can include testing the wireless communication, network connectivity, and various modes of operation.

In some embodiments, RF testing can involve evaluating the RF performance of a WiFi device to ensure it meets the required specifications and regulatory standards. For example, this can involve measuring parameters such as, but not limited to, signal strength, throughput and range.

In some embodiments, interoperability testing can involve testing a device to ensure it interoperates (at least at a threshold level) with various WiFi routers, APs and other devices, following particular WiFi standards.

In some embodiments, security testing can involve testing WiFi devices for security vulnerabilities to identify and address potential weaknesses that could be exploited by malicious actors.

In some embodiments, firmware and software validation testing can involve testing the firmware and/or software of a device to ensure that such are stable, reliable and free from critical bugs or errors. For example, this can involve running a series of test cases and simulations.

In some embodiments, regulatory compliance testing can involve ensuring that WiFi devices meet various regulatory standards, such as those set by the Federal Communications Commission (FCC) in the United States and/or the European Telecommunications Standards Institute (ETSI) in Europe. For example, a device's emissions, power levels and frequency usage can be tested to comply with these regulations.

And, in some embodiments, QA and QC testing can involve the application of assurance and/or control measures to identify and rectify any manufacturing defects or inconsistencies.

As such, such device testing, inter alia other tests, can involve calibration operations to optimize performance and/or ensure the device, its firmware and/or software meet required specifications and/or operate efficiently and properly.

Accordingly, as discussed herein, disclosed are systems and methods that provide a novel functional, computerized testing framework for an integrated, unified standard testbed for network (e.g., WiFi) devices. In some embodiments, the disclosed framework involves components referred to as OpenSync Reference Testbed (OSRT) and Unified Standard Testbed (USTB). OSRT provides a reference testbed for end-to-end (E2E) system testing for firmware release verification (FRV) and for functional unit testing (FUT). USTB corresponds to standard devices, software images, wiring schemes, and the process for setting up and running a functional testbed for networked devices. In some embodiments, OSRT can include a fully assembled USTB with a predetermined number (e.g., three (3)) of reference extenders, which can allow for the testing configuration and functionality discussed herein.

According to some embodiments, as discussed herein, the disclosed framework can provide novel functionality for testing, verifying and configuring network equipment and connections for a particular and/or set of software stacks. As evident from the disclosure herein, the disclosed framework can provide a predefined and standardized testbed configuration and setup, automated Dynamic Host Configuration Protocol (DHCP) reservation tools for included devices, standard configuration for network switches, and the like. Moreover, the disclosed framework can support “devices under tests” (DUTs) via one or more ports, and can provide separated testing environments for specific types of networks via standardized automated test case execution that provide predictable and repeatable results.

According to some embodiments, a method is disclosed for performing integrated device testing, verification and configuration based therefrom. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at a device to perform a method for performing integrated device testing, verification and configuration based therefrom.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIGS. 1A-1B provide example configurations within which the systems and methods disclosed herein could be implemented according to some embodiments of the present disclosure;

FIG. 2 is a block diagram of functional components of an AP device according to some embodiments of the present disclosure;

FIG. 3 is a block diagram illustrating components of an exemplary system according to some embodiments of the present disclosure;

FIG. 4 illustrates an exemplary workflow according to some embodiments of the present disclosure;

FIG. 5 depicts an exemplary implementation of an architecture according to some embodiments of the present disclosure;

FIG. 6 depicts an exemplary implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

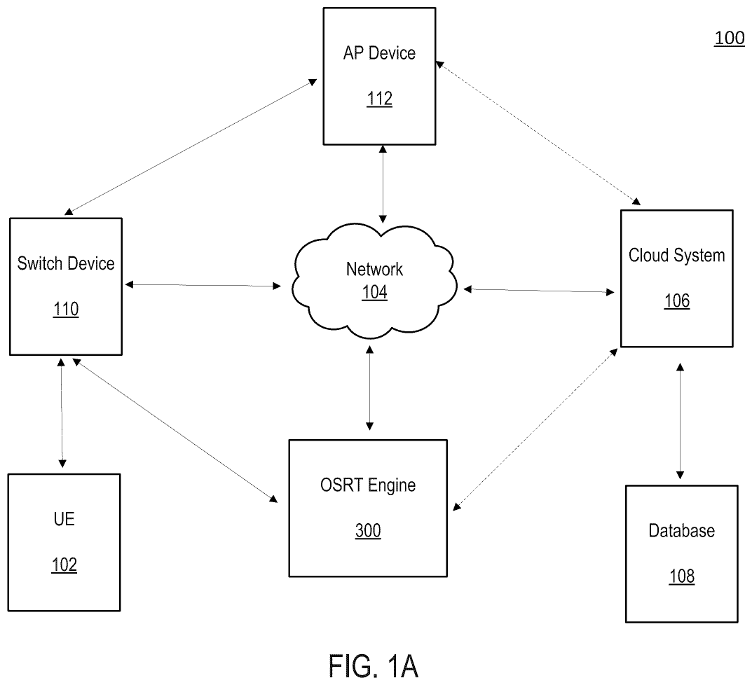

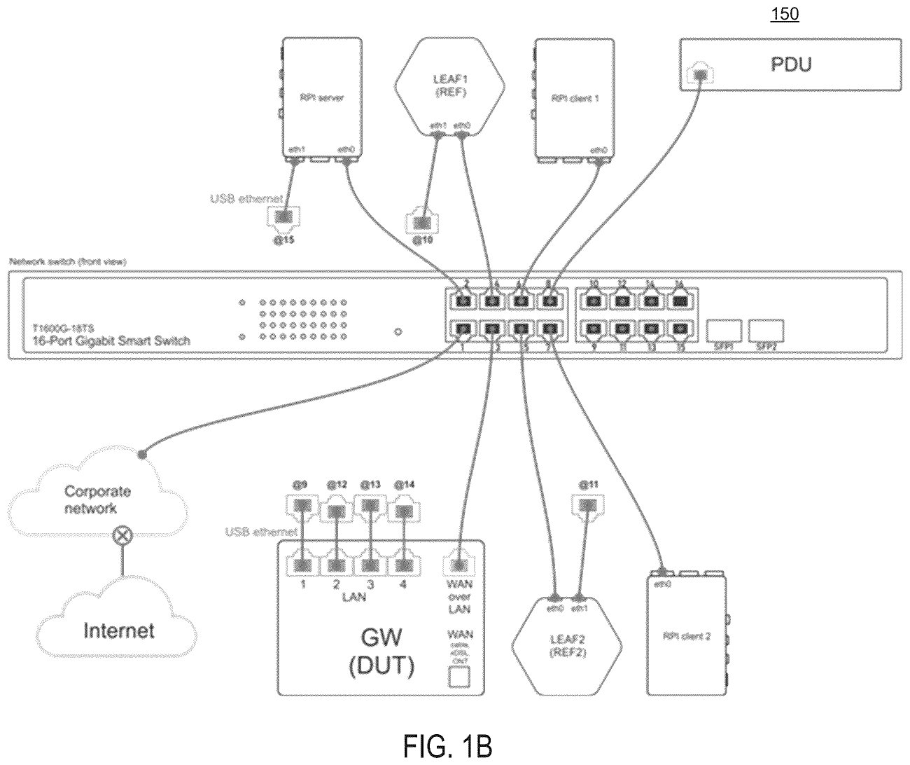

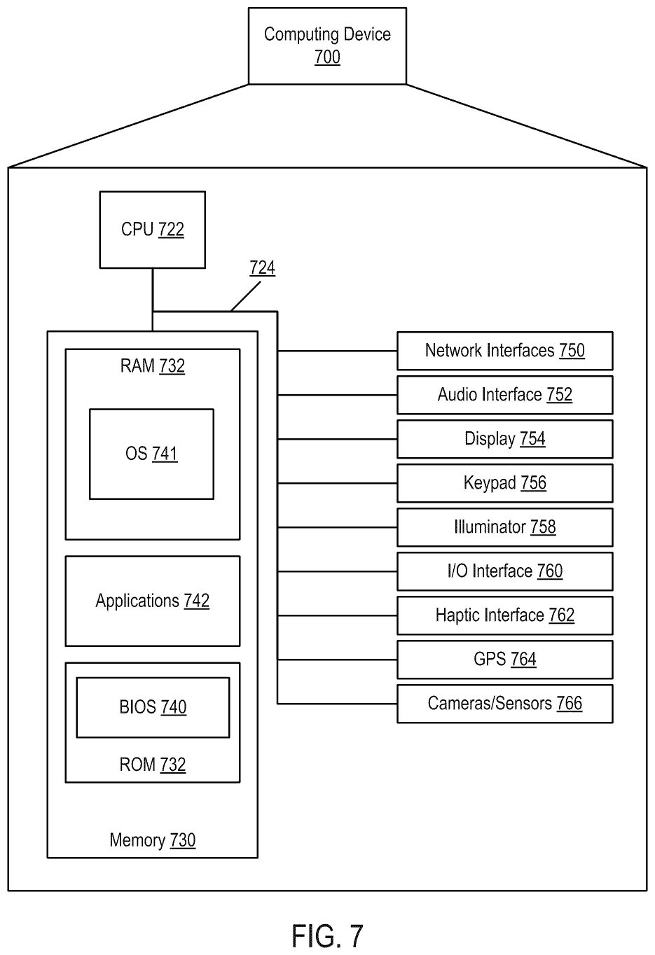

Certain embodiments and principles will be discussed in more detail with reference to the figures. With reference to FIG. 1A, system 100 is depicted which includes user equipment (UE) 102 (e.g., a client device, as mentioned above and discussed below in relation to FIG. 7), access point (AP) device 112, network 104, cloud system 106, database 108, switch device 110 and OSRT engine 300. It should be understood that while system 100 is depicted as including such components, it should not be construed as limiting, as one of ordinary skill in the art would readily understand that varying numbers of UEs, AP devices, peripheral devices, cloud systems, databases and networks can be utilized; however, for purposes of explanation, system 100 is discussed in relation to the example depiction in FIG. 1A.

According to some embodiments, UE 102 can be any type of device, such as, but not limited to, a mobile phone, tablet, laptop, sensor, IoT device, wearable device, autonomous machine, and any other device equipped with a cellular or wireless or wired transceiver.

In some embodiments, peripheral devices (not shown) can be connected to UE 102, and can be any type of peripheral device, such as, but not limited to, a wearable device (e.g., smart watch), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

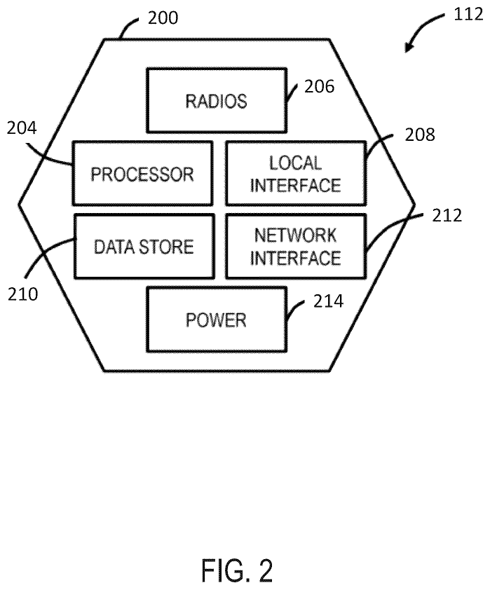

Turning to FIG. 2, depicted is an example AP device 112 and its corresponding functional components. AP device 112 can include, but is not limited to, a physical form factor 200, which contains a processor 204, one or more radios 206, a local interface 208, a data store 210, a network interface 212 and power 214. It should be understood by those of ordinary skill in the depicted AP device 112 is depicted in an oversimplified manner, and a practical embodiment may include additional components and suitably configured processing logic to support features described herein or known or conventional operating features that are not described in detail herein.

In some embodiments, the form factor 200 is a compact physical implementation where the AP device 112 directly plugs into an electrical socket and is physically supported by the electrical plug connected to the electrical socket.

In some embodiments, processor 204 is a hardware device for executing software instructions. Processor 204 can be any custom made or commercially available processor, a central processing unit (CPU), an auxiliary processor among several processors associated with a mobile device, a semiconductor-based microprocessor (in the form of a microchip or chip set), or generally any device for executing software instructions. When the AP device 112 is in operation, the processor 204 can be configured to execute software stored within memory or the data store 210, to communicate data to and from the memory or the data store 210, and to generally control operations of the AP device 112 pursuant to the software instructions. In some embodiments, the processor 204 may include a mobile-optimized processor such as optimized for power consumption and mobile applications.

In some embodiments, radios 206 can enable wireless communication in a distributed Wi-Fi system. Radios 206 can operate according to the IEEE 802.11 standard. In some embodiments, radios 206 can include address, control and/or data connections to enable appropriate communications of a Wi-Fi system. As described herein, AP device 112 includes one or more radios to support different links (e.g., backhaul links and client links). Such optimization can determine the configuration of the radios 206—such as, for example, bandwidth, channels, topology, and the like. In some embodiments, AP device 112 can support dual-band operation simultaneously operating 2.4 GHZ (2.4G) and 5 GHZ (5G) 2×2 Multiple Input, Multiple Output (MIMO) 802.11b/g/n/ac/ax radios capable of operating at 2.4 GHZ, 5 GHZ, and 6 GHZ. Additionally, AP device 112 can be adapted to operate (e.g., send and receive signals) over Bluetooth, Wi-Fi, Cellular (Long-Term Evolution (LTE), 5G, and the like), Ultra-Wide Band (UWB), Matter, ZigBee, NFC, millimeter waves technologies (60 GHz radar), and others of the like. AP device 112 can further include antennas supporting a plurality of protocols at a plurality of frequencies for wireless communication.

In some embodiments, local interface 208 can be configured for local communication to AP device 112 and can be either a wired connection or wireless connection, such as Bluetooth or the like. Since AP device 112 can be configured via the cloud, an onboarding process may be required to first establish connectivity for a newly turned on AP device 112. In some embodiments, AP device 112 can also include the local interface 108 allowing connectivity to UE 102 for onboarding to a Wi-Fi network, such as through an app on the UE 102.

In some embodiments, data store 210 is used to store data, and can include any type of volatile memory elements (e.g., random access memory (RAM, such as DRAM, SRAM, SDRAM, and the like)), nonvolatile memory elements (e.g., ROM, hard drive, tape, CD-ROM, and the like), and combinations thereof. Moreover, data store 210 may incorporate electronic, magnetic, optical, and/or other types of storage media.

In some embodiments, network interface 212 provides wired connectivity to AP device 112. Network interface 112 may be used to enable AP device 112 to communicate to a modem/router. In some embodiments, network interface 212 can be used to provide local connectivity to a Wi-Fi client device or user device. In some embodiments, network interface 212 may include address, control, and/or data connections to enable appropriate communications on the network.

In some embodiments, processor 204 and the data store 210 can include software and/or firmware that controls the operation of AP device 112, data gathering and measurement control, data management, memory management, and communication and control interfaces. In some embodiments, processor 204 and the data store 210 may be configured to implement the various processes, algorithms, methods, techniques, and the like, as described herein.

Turning back to FIG. 1A, according to some embodiments, switch device 110 can be a specialized piece of equipment used to simulate and control various networking conditions in a controlled testing environment. As discussed above, switch device 110 can provide the OSRT and USTB functionality so as to enable a unified, standard testbed, which can be used for testing and configuration within various types of network operating environments (e.g., at a location, mobile, and a varying number of UEs and/or AP devices connected thereto). As discussed herein, switch device 110 can enable the operational evaluation of the performance and behavior of WiFi devices under different network scenarios. Switch device 110 can therefore operate as a “network emulator” and/or “network simulator.”

According to some embodiments, switch device 110 can provide features and/or functionalities for WiFi testing that include, but are not limited to, network scenario replication, traffic shaping, emulation of mobile networks, protocol manipulation, interference generation, multiple user emulation, monitoring and reporting, automation and scripting support, and the like.

According to some embodiments, network scenario replication can involve switch device 110 replicating various real-world network conditions, such as latency, packet loss, jitter, bandwidth limitations, and the like, which can enable testing environments to mimic different types of network environments.

In some embodiments, traffic shaping can involve switch device 110 shaping the network traffic to simulate different network speeds and conditions. For example, this can assist in assessing how WiFi devices can perform under varying bandwidths.

In some embodiments, emulation of mobile networks can involve switch device 110 emulating the behavior of mobile networks, such as, for example, 3G, 4G, or 5G; therefore, enabling switch device 110 to introduce the characteristics of a wireless communication into a testing environment.

In some embodiments, protocol manipulation can involve switch device 110 to manipulate network protocols to simulate challenging situations and evaluate how WiFi devices respond to such scenarios.

In some embodiments, with regard to interference generation, WiFi testing can involve evaluating the device's performance in the presence of interference from other devices and/or neighboring networks. Accordingly, in some embodiments, switch device 110 can generate interference signals to replicate such scenarios.

In some embodiments, multiple users emulation can involve switch device 110, for testing AP devices and routers, simulating multiple users and/or devices simultaneously connecting to the WiFi network, and assessing the device's ability to handle multiple connections efficiently.

In some embodiments, switch device 110 can monitor and report network conditions, and device performance metrics during testing, which can be utilized to automate the configuration of the network, device(s) providing the network and/or devices connected thereto.

Accordingly, switch device 110 can support automation and scripting capabilities to streamline testing procedures and enable repeatable test cases, which can be in-line with predefined testing profiles and/or scenarios. Switch device 110 can integrate with other testing tools and frameworks, which can enable a scalable testing infrastructure. As provided herein, switch device 110 can provide functionality for identifying potential performance bottlenecks, vulnerabilities and areas for improvement, which can be leveraged to fine-tune the network in actual WiFi deployments.

Turning to FIG. 1B, depicted is an example system 150 which provides an operating and/or testing environment for switch device 110 as a 16-port network switch performing a test in an “off-line” environment (or without a cloud connection). The depicted example system 150 is a non-limiting example embodiment for implementation of the OSRT framework discussed herein. As depicted in system 150, components can include, but are not limited to, a Raspberry Pi (RPI) server (or any other type of known or to be known similar type of server, e.g., x86 miniPC server, for example) (e.g., which can support on-board dual band Wi-Fi (2.4 GHZ and 5 GHZ) as well as Bluetooth), RPI client, 2×GB-BACE-3160 or 2× Shuttle NC10U, network switch (e.g., switch device 110, which can include, for example, a smart switch, such as TP-LINK TL-SG2218, that enables the testbed to be configured for the broadest range of available gateway devices, and enables a test environment to avoid potential future issues with newly added tests, test profiles and/or scenarios); gateway (GW) and DUT (e.g., a device currently being tested-DUT, here can be any gateway or extender device that runs the particular software stack), leaf nodes (REF) (e.g., extender devices running a type of software required for certain test cases (e.g., OpenSync™, for example), and a power distribution unit (PDU) for providing power.

It should be understood that system 150 is non-limiting, and should not be construed to provide the number of ports, connections and/or configuration of switch device 110's operational functionality. For example, fewer ports, more ports and/or modified configurations (e.g., for mobile environments) can be implemented via switch device 110. In another non-limiting example, rather than RPI server being connected, a cloud server/device can be utilized so that cloud data can be provided to provide a different functioning test (e.g., a test aligned with a set of real-world networking parameters, for example).

Turning back to FIG. 1A, in some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider, which has associated network resources hosted on the internet or private network (e.g., network 104), which enables (via engine 300) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, switch device 110, and the services and applications provided by cloud system 106 and/or OSRT engine 300).

In some embodiments, for example, cloud system 106 can provide a private/proprietary management platform, whereby engine 300, discussed infra, corresponds to the novel functionality system 106 enables, hosts and provides to a network 104 and other devices/platforms operating thereon.

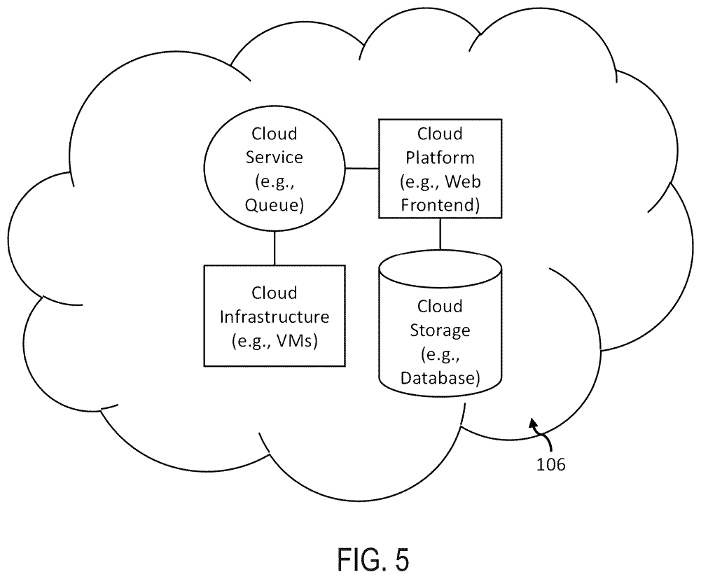

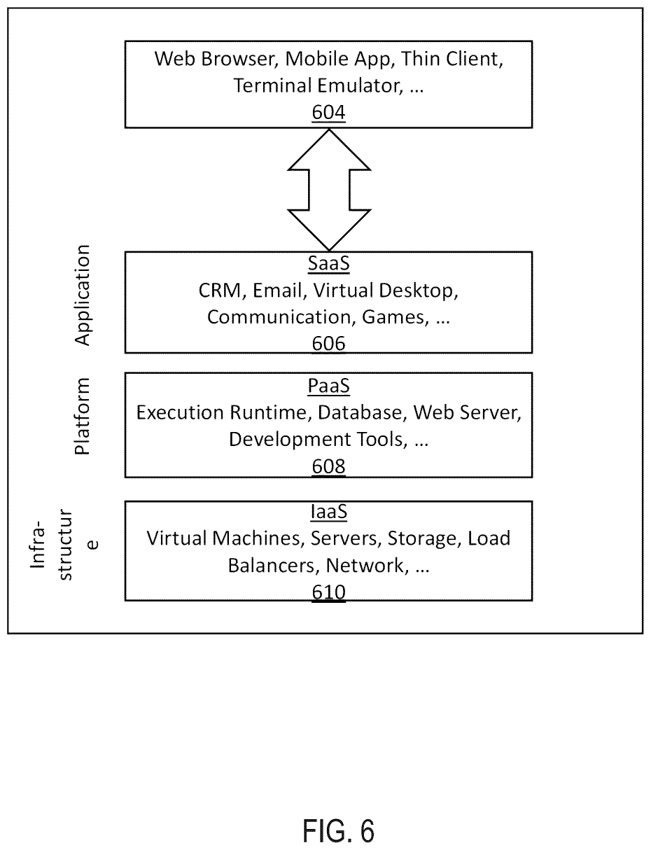

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 610, platform as a service (PaaS) 608, and/or software as a service (SaaS) 606 using a web browser, mobile app, thin client, terminal emulator or other endpoint 604. FIGS. 5 and 6 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 300 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

OSRT engine 300, as discussed above and further below in more detail, can include components for the disclosed functionality. According to some embodiments, OSRT engine 300 may be a special purpose machine or processor, and can be hosted by a device on network 104, within cloud system 106, on AP device 112, UE 102 and/or switch device 110. In some embodiments, engine 300 may be hosted by a server and/or set of servers associated with cloud system 106.

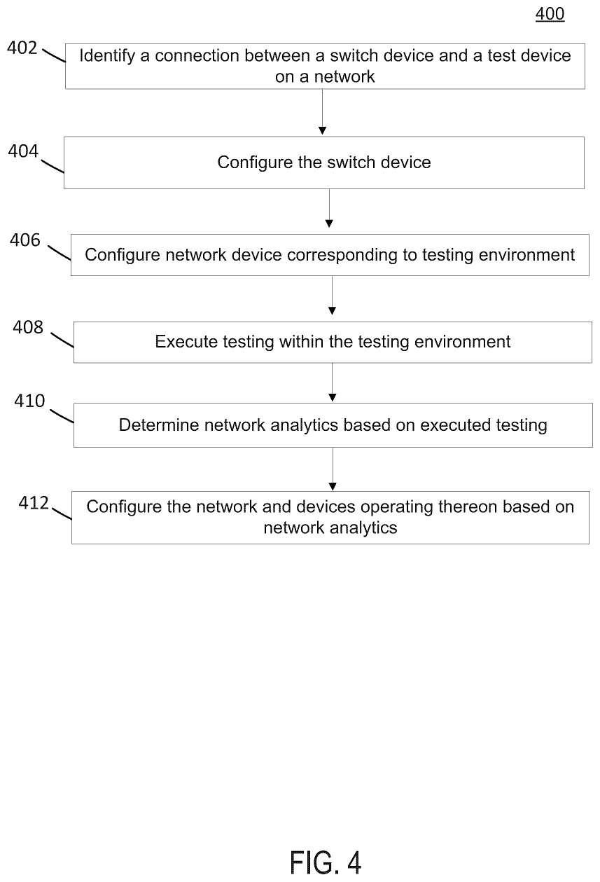

According to some embodiments, as discussed in more detail below, OSRT engine 300 may be configured to implement and/or control a plurality of services and/or microservices, where each of the plurality of services/microservices are configured to execute a plurality of workflows associated with performing the disclosed network management. Non-limiting embodiments of such workflows are provided below in relation to at least FIG. 4.

According to some embodiments, as discussed above, OSRT engine 300 may function as an application provided by cloud system 106. In some embodiments, engine 300 may function as an application installed on a server(s), network location and/or other type of network resource associated with system 106. In some embodiments, engine 300 may function as an application installed and/or executing on AP device 112, UE 102 and/or switch device 110. In some embodiments, such application may be a web-based application accessed by AP device 112, UE 102 and/or switch device 110 over network 104 from cloud system 106. In some embodiments, engine 300 may be configured and/or installed as an augmenting script, program or application (e.g., a plug-in or extension) to another application or program provided by cloud system 106 and/or executing on AP device 112, UE 102 and/or switch device 110.

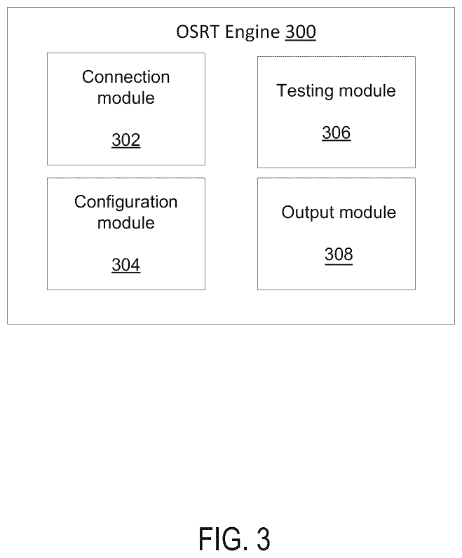

As illustrated in FIG. 3, according to some embodiments, OSRT engine 300 includes connection module 302, configuration module 304, testing module 306 and output module 308. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 300 and each of its modules, and their role within embodiments of the present disclosure will be discussed below.

Turning to FIG. 4, Process 400 provides non-limiting example embodiments for the disclosed network testing, configuration and verification framework. According to some embodiments, Step 402 of Process 400 can be performed by connection module 302 of OSRT engine 300; Steps 404-406 can be performed by configuration module 304; Steps 408-410 can be performed by testing module 306; and Step 412 can be performed by output module 308.

According to some embodiments, Process 400 begins with Step 402 where engine 300 can identify a connection between a switch device and a test device on a network. For example, as depicted in FIG. 1B discussed supra, switch device 110 can be connected to gateway (DUT). In some embodiments, the network can be a “closed” (or local) network for testing purposes (e.g., for which a RPI server can be connected to switch device 110) or can correspond to a cloud-associated network of an active WiFi network (e.g., a cloud server can be connected to switch device 110). Accordingly, as discussed above, the switch device operates to provide an OSRT/USTB testbed for calibration, verification and configuration of network devices.

In some embodiments, Step 402 can involve identification of information related to, but not limited to: IP and/or MAC addresses of the switch device, test device, RPI server or cloud server; identifier (ID) of the switch device, test device, RPI server or cloud server; type of network and/or test device(s); PDU of switch device and corresponding descriptive information related thereto; ethernet or wireless uplink ports; secure socket shell (SSH) connection information; DHCP information; username/password (or other login credentials); and the like, or some combination thereof.

While the discussion herein will reference a single device being tested (e.g., test device), it should not be construed as limiting, as it should be understood that multiple devices can be DUT without departing from the scope of the instant disclosure.

In Step 404, engine 300 can operate to configure the switch device. As discussed herein, the OSRT framework employed by engine 300 provides an automated tool that creates IP reservations on an RPI (or cloud) server. In some embodiments, for example with respect to an RPI server provided network, engine 300 can parse the MAC address tables on the network switch, where the MAC address tables can be populated when the test device connected to each individual port start generating traffic.

As such, in Step 404, engine 300 can configure the switch device, and in some embodiments, PDU of the switch device, to load (or download and execute) an OSRT configuration file to apply the USTB configuration testbed functionality discussed herein. In some embodiments, as discussed above, engine 300 can execute the OSRT configuration file which includes information related to, but not limited to, a type of network (e.g., “closed” or local—RPI server provided; or cloud-based, discussed supra), a type of OSRT framework (e.g., large, small or mobile, for example, where the large versus small corresponds to threshold valued number of ports for connected testing devices), and the like, or some combination thereof.

In Step 406, engine 300 can operate to configure the network device corresponding to the testing environment. For example, RPI server or cloud server can be configured to enable the testing environment. According to some embodiments, such configuration can involve, but is not limited to, reserving and assigning IP addresses (which may be specific to a MAC address, in some embodiments), configure DHCP, reserve interfaces on the switch device, identify and assign host(s) ID, configure SSH server for RPI server, identify and connect WAN/LAN ports, and the like, or some combination thereof.

Accordingly, in some embodiments, by way of a non-limiting example, Steps 404-406 correlate to the set up of system 150 for which testing operations can commence.

Thus, in Step 408, engine 300 can execute a testing environment (e.g., perform executable testing operations, and monitoring and reporting based therefrom). According to some embodiments, as discussed above, such testing can include, but is not limited to, functional testing, RF testing, interoperability testing, security testing, firmware and software validation testing, regulatory compliance testing, QA and QC, integration testing and the like, or some combination thereof.

According to some embodiments, when conducting WiFi testing via a switch device (e.g., with regard to an RPI server or cloud server), various types of network data can be collected depending on the performance and reliability of the network. For example, such types of data can include, but are not limited to, packet captures (PCAPs), signal strength and quality, data rates, connection duration, client information, network latency, network throughput, channel utilization, error rates, roaming behavior, authentication and encryption information, traffic analysis, and the like, or some combination thereof.

In Step 410, engine 300 can perform a computational analysis of the collected network data from a test. In some embodiments, such analysis can result in metrics, values, newly created data and/or data structures, and the like, or some combination thereof, which provide insights into the current configuration of the network operating environment for the DUT.

According to some embodiments, such analysis can be performed via implementation/execution of any type of known or to be known computational analysis technique, algorithm, mechanism or technology.

In some embodiments, engine 300 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 300 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

As such, based on such computational analysis, engine 300 can determine the network analytics of the DUT for that specifically configured network environment. In some embodiments, the information related to the network analytics can be stored in database 108, as discussed above.

In some embodiments, in Step 412, engine 300 can leverage the determined and compiled network analytics (from Step 410 based on the testing in Step 408) to configure the network and/or network devices connected thereto. According to some embodiments, when certain network parameters, attributes or characteristics (e.g., latency, for example) is at or a below a threshold level, parameters and/or components of the AP device and/or DUT can be configured/modified to ensure such network parameters, attributes or characteristics are within an acceptable range or comply with certain regulations, rules or parameters for a properly configured and operating network.

FIG. 7 is a schematic diagram illustrating a client device showing an example embodiment of a client device that may be used within the present disclosure. Client device 700 may include many more or less components than those shown in FIG. 7. However, the components shown are sufficient to disclose an illustrative embodiment for implementing the present disclosure. Client device 700 may represent, for example, UE 102 discussed above at least in relation to FIG. 1.

As shown in the figure, in some embodiments, Client device 700 includes a processing unit (CPU) 722 in communication with a mass memory 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device 700 may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 300 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:

Aspect 1. A method comprising:
identifying, by a switch device, a connection with a test device, the connection corresponding to a testing environment, the testing environment comprising a server;
configuring the switch device based on a type of reference testbed, the reference testbed comprising functionality enabled by a Unified Standard Testbed (USTB) corresponding to a type of the testing environment;
executing, by the switch device, via the reference testbed, a test of the test device, the test comprising a simulation of network traffic within the test environment;
determining, by the switch device, network analytics for the test device based on the executed test; and
configuring the test device based on the determined network analytics.

Aspect 2. The method of aspect 1, wherein the configuration of the test device corresponds to a connectivity of a WiFi network associated with a cloud service.

Aspect 3. The method of aspect 1, wherein the configuration of the test device corresponds to the testing environment, wherein the test is performed again after the configuration.

Aspect 4. The method of aspect 1, further comprising:
collecting, based on the test of the test device, network data for the test device; and
analyzing, via at least one machine learning or artificial intelligence model, the network data, wherein the determined network analytics are based on the analysis.

Aspect 5. The method of aspect 1, wherein the connection with the test device corresponds to a WiFi network at a location, wherein the configuration further comprises configuring the WiFi network based on the determined network analytics.

Aspect 6. The method of aspect 1,
wherein the test comprises at least one of: functional testing, radio frequency (RF) testing, interoperability testing, security testing, firmware and software validation testing, regulatory compliance testing, and Quality Assurance (QA) and Quality Control (QC) testing, and
wherein the test involves analysis based on network scenario replication, traffic shaping, emulation of mobile networks, protocol manipulation, interference generation, multiple user emulation, monitoring and reporting, and automation and scripting support.

Aspect 7. The method of aspect 1, wherein the server is a Raspberry PI server (or any other type of known or to be known similar type of server, as discussed supra).

Aspect 8. The method of aspect 1, wherein the server is a cloud-based server.

Aspect 9. The method of aspect 1, wherein the switch device is connected to a plurality of test devices, wherein the plurality of test devices corresponds to a number of available ports on the switch device.

Aspect 10. The method of aspect 1, wherein the type of testing environment corresponds to a number of test devices.

Aspect 11. The method of aspect 1, wherein the type of testing environment is mobile.

Aspect 12. The method of aspect 1, wherein the reference testbed is an OpenSync Reference Testbed (OSRT), wherein the configuration of the switch device is based on OSRT functionality.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, shell, bash, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by a switch device, a connection with a test device, the connection corresponding to a testing environment, the testing environment comprising a server;
configuring the switch device based on a type of reference testbed, the reference testbed comprising functionality enabled by a Unified Standard Testbed (USTB) corresponding to a type of the testing environment;
executing, by the switch device, via the reference testbed, a test of the test device, the test comprising a simulation of network traffic within the test environment;
determining, by the switch device, network analytics for the test device based on the executed test; and
configuring the test device based on the determined network analytics.

2. The method of claim 1, wherein the configuration of the test device corresponds to a connectivity of a WiFi network associated with a cloud service.

3. The method of claim 1, wherein the configuration of the test device corresponds to the testing environment, wherein the test is performed again after the configuration.

4. The method of claim 1, further comprising:
collecting, based on the test of the test device, network data for the test device; and
analyzing, via at least one machine learning or artificial intelligence model, the network data, wherein the determined network analytics are based on the analysis.

5. The method of claim 1, wherein the connection with the test device corresponds to a WiFi network at a location, wherein the configuration further comprises configuring the WiFi network based on the determined network analytics.

6. The method of claim 1,
wherein the test comprises at least one of: functional testing, radio frequency (RF) testing, interoperability testing, security testing, firmware and software validation testing, regulatory compliance testing, and Quality Assurance (QA) and Quality Control (QC) testing, and
wherein the test involves analysis based on network scenario replication, traffic shaping, emulation of mobile networks, protocol manipulation, interference generation, multiple user emulation, monitoring and reporting, and automation and scripting support.

7. The method of claim 1, wherein the server is a Raspberry PI server.

8. The method of claim 1, wherein the server is a cloud-based server.

9. The method of claim 1, wherein the switch device is connected to a plurality of test devices, wherein the plurality of test devices corresponds to a number of available ports on the switch device.

10. The method of claim 1, wherein the type of testing environment corresponds to a number of test devices.

11. The method of claim 1, wherein the type of testing environment is mobile.

12. The method of claim 1, wherein the reference testbed is an OpenSync Reference Testbed (OSRT), wherein the configuration of the switch device is based on OSRT functionality.

13. A switch device comprising:
a processor configured to:
identify a connection with a test device, the connection corresponding to a testing environment, the testing environment comprising a server;
configure the switch device based on a type of reference testbed, the reference testbed comprising functionality enabled by a Unified Standard Testbed (USTB) corresponding to a type of the testing environment;
execute, via the reference testbed, a test of the test device, the test comprising a simulation of network traffic within the test environment;
determine network analytics for the test device based on the executed test; and
configure the test device based on the determined network analytics.

14. The switch device of claim 13, wherein the configuration of the test device corresponds to a connectivity of a WiFi network associated with a cloud service.

15. The switch device of claim 13, wherein the configuration of the test device corresponds to the testing environment, wherein the test is performed again after the configuration.

16. The switch device of claim 13, wherein the connection with the test device corresponds to a WiFi network at a location, wherein the configuration further comprises configuring the WiFi network based on the determined network analytics.

17. A non-transitory computer-readable storage medium tangibly encoded with computer-executable instructions that when executed by a switch device, perform a method comprising:
identifying, by the switch device, a connection with a test device, the connection corresponding to a testing environment, the testing environment comprising a server;
configuring the switch device based on a type of reference testbed, the reference testbed comprising functionality enabled by a Unified Standard Testbed (USTB) corresponding to a type of the testing environment;
executing, by the switch device, via the reference testbed, a test of the test device, the test comprising a simulation of network traffic within the test environment;
determining, by the switch device, network analytics for the test device based on the executed test; and
configuring the test device based on the determined network analytics.

18. The non-transitory computer-readable storage medium of claim 17, wherein the configuration of the test device corresponds to a connectivity of a WiFi network associated with a cloud service.

19. The non-transitory computer-readable storage medium of claim 17, wherein the configuration of the test device corresponds to the testing environment, wherein the test is performed again after the configuration.

20. The non-transitory computer-readable storage medium of claim 17, wherein the connection with the test device corresponds to a WiFi network at a location, wherein the configuration further comprises configuring the WiFi network based on the determined network analytics.
